(19) United States
(12) Patent Application Publication
(10) Pub. No.: US 2009/0145274 A1
(43) Pub. Date: Jun. 11, 2009

(54) DEMOLITION SHEARS

(75) Inventors: Daniel L. Mikrut, Chillicothe, IL (US); Blake J. Markovits, Lavallette, NJ (US); Gary Markovits, Lavallette, NJ (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 11/951,464

(22) Filed: Dec. 6, 2007

(51) Int. Cl. B23D 17/00; B23D 17/06

(52) U.S. Cl. 83/53; 30/134; 30/245

(57) ABSTRACT

A demolition tool is provided. The demolition tool has a first jaw, a second jaw, a linkage assembly, and an actuator. The second jaw is pivotally coupled to the first jaw and the linkage assembly is coupled to the first and the second jaws. The actuator is coupled to the linkage assembly and the first jaw and has an extension stroke. The linkage assembly first closes and then opens the second jaw with respect to the first jaw over the extension stroke.

### TECHNICAL FIELD

This disclosure relates generally to a work tool for a machine, and more particularly to demolition shears for construction or demolition equipment.

### BACKGROUND

Demolition shears are work tools with relative moveable powered jaws equipped with blades of hardened steel on both an upper jaw and a lower jaw, with a cutting and piercing tip provided on the distal end of each jaw. These shears are typically adapted for mounting on a hydraulic excavator or backhoe loader for shearing metal, but the shears may also be used for cracking or crushing concrete or other construction debris. In these applications, demolition shears are subjected to intense stresses that abrade, distort, overheat and destroy the blades. When this occurs, the blades may spread apart like a pair of flexible scissors, become loose and prone to jams, especially for applications involving cutting wire or thin steel.

U.S. Pat. No. 5,187,868 to Hall (“the '868 patent”) provides one solution for reducing jaw blade jams. The '868 patent discloses a demolition shear having adjustable jaw spacing for optimal cutting. The '868 patent discloses adjustable linear thrust bearings on a pivot axle to control the blade gap. While the '868 patent discloses a passive system for potentially reducing the number of blade jams that may occur, it does little for recovering from jams that have already occurred.

With existing shears, the hydraulic cylinder powering the moveable jaw extends the rod on the closing stroke and retracts the rod on the opening stroke to increase cycle times. However, because the hydraulic area of the cylinder end exceeds that of the rod end, the closing stroke generates more force than the opening stroke. As a result, the machine hydraulics are often unable to open the jaw blades after a jam.

The present disclosure is directed to overcome one or more of the problems as set forth above.

### SUMMARY

In one aspect of the present disclosure, a demolition tool is provided. The demolition tool has a first jaw, a second jaw, a linkage assembly, and an actuator. The second jaw is pivotally coupled to the first jaw and the linkage assembly is coupled to the first and the second jaws. The actuator is coupled to the linkage assembly and the first jaw and has an extension stroke. The linkage assembly first closes and then opens the second jaw with respect to the first jaw over the extension stroke.

In another aspect of the present disclosure, a demolition tool is provided. The demolition tool has a frame, a first jaw, a second jaw, a linkage assembly, and a hydraulic cylinder. The first jaw is attached to the frame and the second jaw is pivotally coupled to the first jaw. The linkage assembly is coupled to the frame and the second jaw. The hydraulic cylinder is coupled to the linkage assembly and the frame and has an extension stroke. The linkage assembly first closes and then opens the second jaw with respect to the first jaw over the extension stroke.

In a third aspect of the present disclosure, a method of operating a demolition tool is provided. The demolition tool has a first jaw, a second jaw pivotally coupled to the first jaw, a linkage assembly coupled to the first and the second jaws, and an actuator coupled to the linkage assembly and the first jaw and having an extension stroke. The method includes the step of closing and then opening the second jaw with respect to the first jaw over the extension stroke.

### BRIEF DESCRIPTION OF THE DRAWINGS

FIG. 1 is a side view of a shear with its jaw near full open according to the present disclosure.

FIG. 2 is a side view of the shear of FIG. 1 with its jaw closing.

FIG. 3 is a side view of the shear of FIG. 1 with its jaw closed.

FIG. 4 is a side view of the shear of FIG. 1 with its jaw partially open and its rod fully extended.

### DETAILED DESCRIPTION

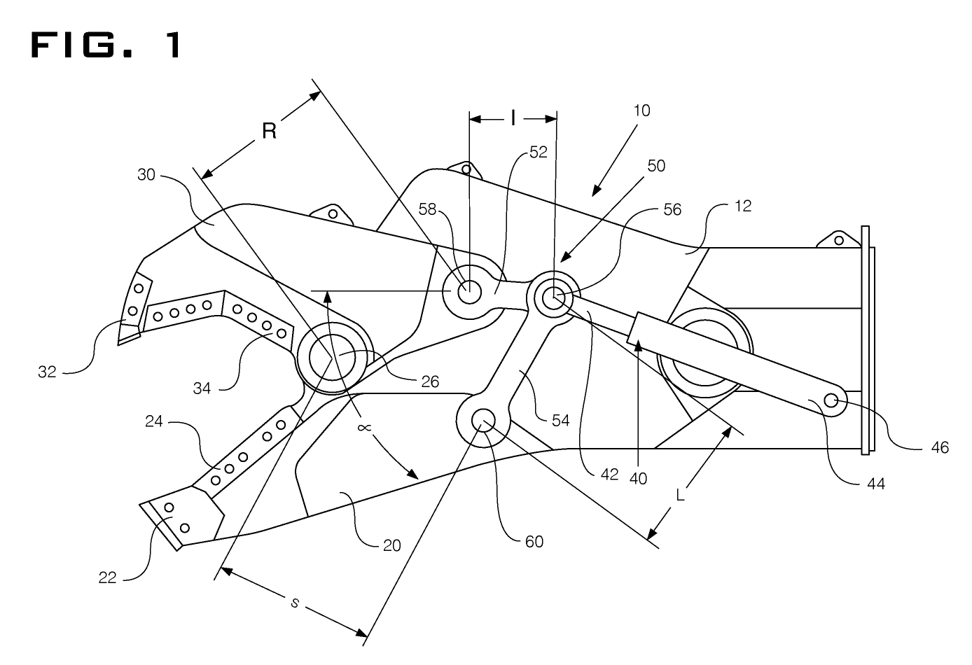

FIG. 1 illustrates an exemplary shear 10. The shear 10 may be a metal demolition shear or a scrap shear. The shear 10 may be attached to the boom structure of, for example, an excavator, a backhoe loader, or some other excavating or earth-moving excavation equipment. The shear 10 includes a fixed or stationary lower jaw 20 extending from a frame 12, a movable upper jaw 30, and a jaw pivot 26 pivotally connecting the lower jaw 20 and the upper jaw 30. The lower jaw 20 may have a tip insert 22 and a blade insert 24. Similarly, the upper jaw 30 may have a tip insert 32 and a blade insert 34. The tip inserts 22, 32, and blade inserts 24, 34 may be replaceable and detachably mounted to the lower jaw 20 and the upper jaw 30, respectively. The inserts 22, 32, 24, 34 may be made from a hard metal, for example hardened steel, and may also be indexable.

The shear also includes a linkage assembly 50 coupling a hydraulic cylinder 40 to the lower jaw 20 and the upper jaw 30. The linkage assembly 50 includes a first power link 52 pivotally connected to a second control link 54 about a linkage pivot 56. The first link 52 is also pivotally connected to the upper jaw 30 about a first pivot 58. The second link 54 is pivotally connected to the lower jaw about a second pivot 60. The first link 52 also has a length of “l,” while the second link 54 has a length of “L”. As shown in FIG. 1, the length of “L” exceeds that of “l,” with a ratio of L/l exceeding one. It should be appreciated that other ratios of L/l may also be used depending on the desired application, such as 2 to 10, for example. In addition, the distance between the jaw pivot 26 and the first pivot 58 is “R,” while the distance between the jaw pivot 26 and the second pivot 60 is “s.” In order for the linkage pivot 56 to push through the linkage assembly 50 as described below, the following equation must be satisfied:

L+l<R+s

The hydraulic cylinder 40 includes a rod end 42 and a cylinder end 44. The cylinder end 44 is pivotally attached to the frame 12 of the shear 10 about a cylinder pivot 46. However, the hydraulic cylinder 40 may also be secured to the frame 12 through some other attachment technique known in the art, such as pivotally securing the cylinder 40 to the frame 12 about a trunnion (not shown) to allow for an increased cylinder stroke. The rod end 42 is pivotally attached to the linkage assembly 50 about the linkage pivot 56.

### INDUSTRIAL APPLICABILITY

The disclosed shear 10 may be applicable to any shear that includes demolition shears and scrap shears. The operation of the shear 10 will now be explained.

FIG. 1 illustrates the shear 10 with its upper jaw 30 near full open according to the present disclosure. In order to close the upper jaw 30 with respect to lower jaw 20, an operator of a machine may activate a control lever or button to either indirectly or directly command a valve to send pressurized hydraulic fluid from a pump to the hydraulic cylinder 40. The hydraulic fluid extends the rod end 42 from the cylinder 40 over an extension stroke of the hydraulic cylinder 40. At this state, “α,” the angle formed by the intersection of the first and second links 52, 54, is less than 90 degrees.

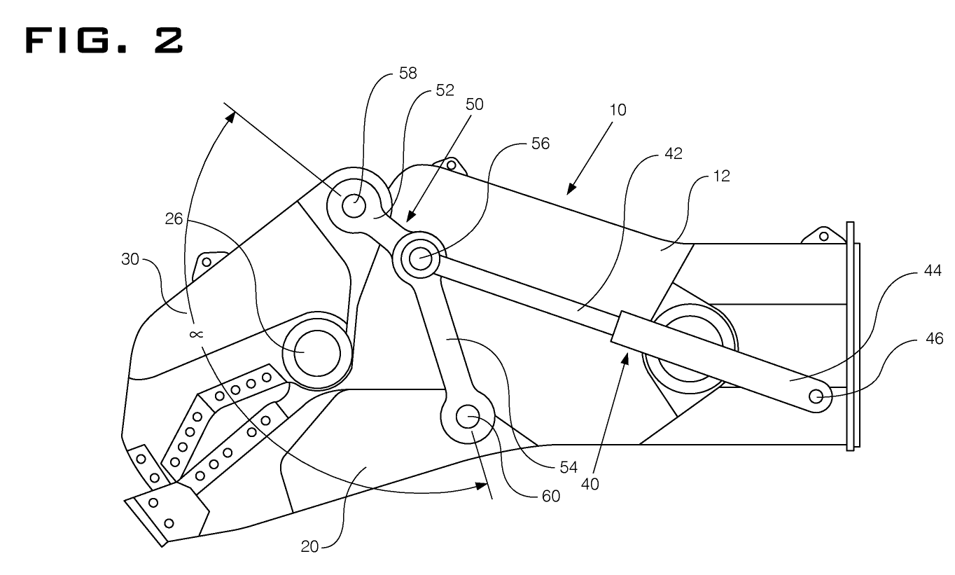

Later in the extension stroke, FIG. 2 illustrates the shear 10 with the linkage assembly 50 opening up. The pressurized hydraulic fluid in the hydraulic cylinder 40 is pushing the rod end 42 out of the cylinder 40, which in turn pushes the linkage assembly 50 at the linkage pivot 56. This causes the angle α to increase and the upper jaw 30 to close with respect to the lower jaw 20.

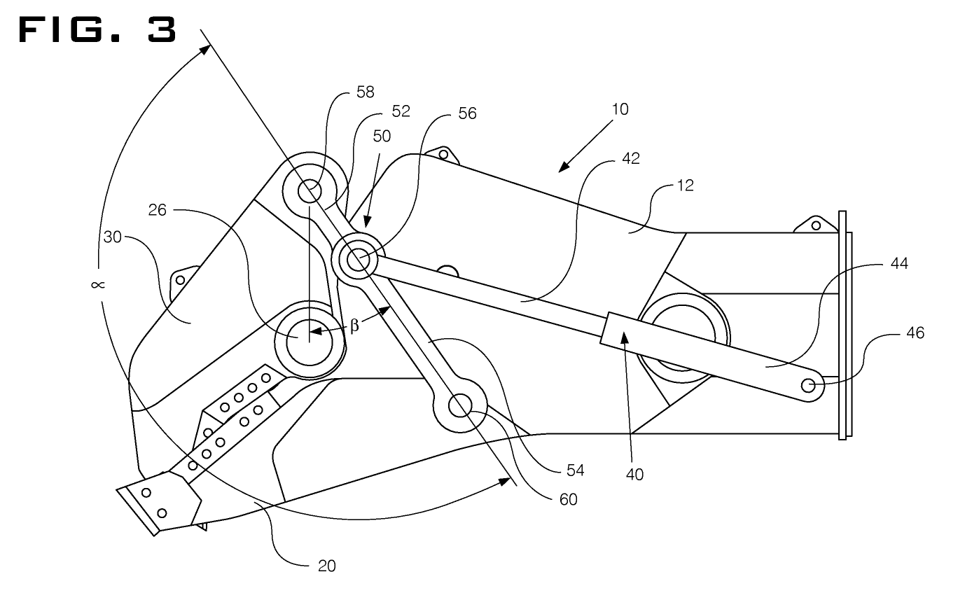

FIG. 3 illustrates the shear 10 with the upper jaw 30 closed with respect to the lower jaw 20. Depending on design parameters, this closed position may be defined as the point at which the upper jaw 30 just touches the lower jaw 20, the point at which the upper jaw 30 overlaps the lower jaw 20, or the point at which the upper jaw 30 has a predefined gap with the lower jaw 20. The pressurized hydraulic fluid has pushed the rod end 42 almost to full extension over the extension stroke of the cylinder 40. The rod end 42 pushes the linkage assembly 50 at the linkage pivot 56. This causes the angle α to equal 180 degrees such that the first link 52 forms a straight line with the second link 54, and the upper jaw 30 to close with respect to the lower jaw 20. Moreover, the second pivot 60 may be positioned such that “β,” which is the angle formed by the intersection of R and the aligned links 52 and 54, is greater than zero. However, the closer second pivot 60 is moved to the cylinder pivot 46, the less space there is for a hydraulic cylinder and the less ability there is to move the linkage assembly 50 from full open to full close.

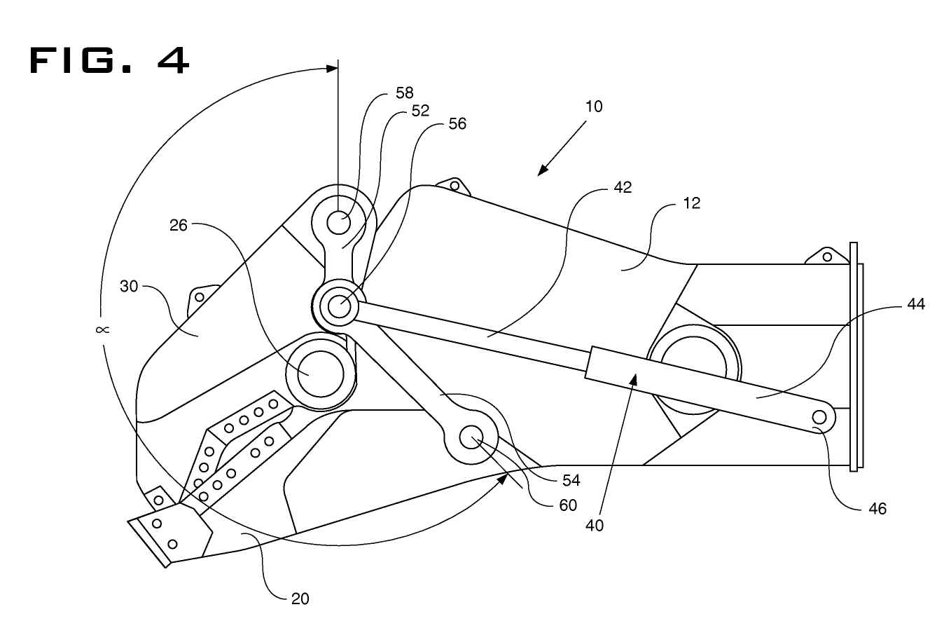

FIG. 4 illustrates the shear 10 at a final point in the extension stroke, a point subsequent to that shown in FIG. 3. As the pressurized hydraulic fluid pushes the rod end 42, the linkage pivot 56 is pushed through the linkage assembly 50, such that the angle “α” increases to an angle greater than 180 degrees. This causes the upper jaw 30 to partially open with respect to the lower jaw 20.

In a first mode of operation, which may be used for standard cutting or demolition, an operator would first extend the rod end 42 from the hydraulic cylinder 40, as described above in FIGS. 1-3. An operator would then retract the rod end 42 into the hydraulic cylinder 40, reversing the steps described above in FIGS. 1-3. During the retraction stroke, as the rod end 42 is pushed back into the cylinder 40, the linkage assembly 50 is pulled at the linkage pivot 56. This causes the angle “α” to decrease from an angle less than 180 degrees to an open angular position, and the upper jaw 30 to open with respect to the lower jaw 20.

In a second mode of operation, which may be used to clear a jam, the operator would activate the control lever or button to either indirectly or directly command a valve to send pressurized hydraulic fluid from the pump to the hydraulic cylinder 40 over its full extension stroke as described above in FIGS. 1-4. As the demolition shears 10 go from the state shown in FIG. 3 to the state shown in FIG. 4, hydraulic fluid would continue to push the rod end 42 out of the cylinder 40, allowing for an increased force to open the shears and clear the jam. Once the jam has been cleared, an operator would retract the rod end 42 into the hydraulic cylinder 40 over its full retraction stroke, reversing the steps described above in FIGS. 1-4. The linkage pivot 56 would be pushed back through the linkage assembly 50, and the angle “α” would decrease from an angle greater than 180 degrees to an open angular position as the upper jaw 30 first closed and then opened with respect to the lower jaw 20.

While the disclosure has been described with reference to details of the illustrated embodiments, these details are not intended to limit the scope of the disclosure as defined in the appended claims. For example, the lower jaw 20 may be pivotally coupled to the frame 12, such that both the lower and upper jaw 20, pivot with respect to the frame 12. Moreover, the orientation of the upper and lower jaws 30, 20 may be reversed. Depending on the application, the pivot positions and lever arms formed by the linkage assembly 50 and the upper and lower jaws 30, 20 may be modified. In addition, the ratio of the length of the first link, “l,” to the length of the second link, “L” may be increased or decreased. Further, the degree of push-through may be increased or decreased depending on the application. For example, the reversing effect of the push-through linkage is greatest when the length of the second link 54, “L,” is reduced and the length of the first link 52, “l,” is increased, particularly if the length of the second link 54 is less than “s”, the distance between the jaw pivot 26 and the second pivot 60. However, sizing the second link 54 small compared with “R,” the distance between the jaw pivot 26 and the first pivot 58, will greatly reduce the angular movement of the shears 10 such that it will not open and close very much. Other actuators may also be used instead of a hydraulic cylinder, such as a linear actuator or a pneumatic actuator.

Other aspects, objects and advantages of this disclosure can be obtained from a study of the drawings, the disclosure, and the appended claims.

What is claimed is:

1. A demolition tool comprising:
a first jaw;
a second jaw pivotally coupled to the first jaw;
a linkage assembly coupled to the first and the second jaws; and
an actuator coupled to the linkage assembly and the first jaw and having an extension stroke;
wherein the linkage assembly first closes and then opens the second jaw with respect to the first jaw over the extension stroke.

2. The demolition tool of claim 1 wherein the actuator has a retraction stroke and the linkage assembly first closes and then opens the second jaw with respect to the first jaw over the retraction stroke.

3. The demolition tool of claim 1 wherein the linkage assembly includes a first link pivotally coupled to a second link, wherein the first link is coupled to the first jaw and the actuator, and wherein the second link is coupled to the second jaw and the actuator.

4. The demolition tool of claim 3 wherein the first link is longer than the second link.

5. The demolition tool of claim 3 wherein the angle formed by the intersection of the first link and the second link is less than 180 degrees at the start of the extension stroke and greater than 180 degrees at the end of the extension stroke.

6. The demolition tool of claim 3 wherein the first jaw is pivotally coupled to the second jaw about a jaw pivot, the first link is pivotally coupled to the first jaw about a first pivot, the second link is pivotally coupled to the second jaw about a second pivot, and the sum of the lengths of the first link and the second link is less than the sum of the distances between the jaw pivot and the first pivot and the jaw pivot and the second pivot.

7. A demolition tool comprising:
a frame;
a first jaw attached to the frame;
a second jaw pivotally coupled to the first jaw;
a linkage assembly coupled to the frame and the second jaw; and
a hydraulic cylinder coupled to the linkage assembly and the frame and having an extension stroke;
wherein the linkage assembly first closes and then opens the second jaw with respect to the first jaw over the extension stroke.

8. The demolition tool of claim 7 wherein the first jaw is fixedly attached to the frame.

9. The demolition tool of claim 7 wherein the hydraulic cylinder has a retraction stroke and the linkage assembly first closes and then opens the second jaw with respect to the first jaw over the retraction stroke.

10. The demolition tool of claim 7 wherein the linkage assembly includes a first link pivotally coupled to a second link, wherein the first link is coupled to the frame and the hydraulic cylinder, and wherein the second link is coupled to the second jaw and the hydraulic cylinder.

11. The demolition tool of claim 10 wherein the first link is longer than the second link.

12. The demolition tool of claim 10 wherein the angle formed by the intersection of the first link and the second link is less than 180 degrees at the start of the extension stroke and greater than 180 degrees at the end of the extension stroke.

13. The demolition tool of claim 7 wherein the demolition tool is a demolition shear.

14. The demolition tool of claim 7 wherein the linkage assembly is pivotally connected to the frame about a first pivot and pivotally connected to the second jaw about a second pivot; and
wherein the hydraulic cylinder is pivotally connected to the linkage assembly about a third pivot.

15. The demolition tool of claim 10 wherein the first jaw is pivotally coupled to the second jaw about a jaw pivot, the first link is pivotally coupled to the frame about a first pivot, the second link is pivotally coupled to the second jaw about a second pivot, and the sum of the lengths of the first link and the second link is less than the sum of the distances between the jaw pivot and the first pivot and the jaw pivot and the second pivot.

16. A method of operating a demolition tool, the demolition tool having a first jaw, a second jaw pivotally coupled to the first jaw, a linkage assembly coupled to the first and the second jaws, and an actuator coupled to the linkage assembly and the first jaw and having an extension stroke, comprising the steps of:
closing and then opening the second jaw with respect to the first jaw over the extension stroke.

17. The method of operating a demolition tool of claim 16, wherein the actuator has a retraction stroke, and further comprising the steps of:
closing and then opening the second jaw with respect to the first jaw over the retraction stroke.

18. The method of operating a demolition tool of claim 16, wherein the linkage assembly includes a first link pivotally coupled to a second link, wherein the first link is coupled to the first jaw and the actuator, and wherein the second link is coupled to the second jaw and the actuator.

19. The method of operating a demolition tool of claim 18, wherein the first link is longer than the second link.

20. The method of operating a demolition tool of claim 18, wherein the angle formed by the intersection of the first link and the second link is less than 180 degrees at the start of the extension stroke and greater than 180 degrees at the end of the extension stroke.
